(19) United States
(12) Patent Application Publication
(10) Pub. No.: US 2023/0074320 A1
(43) Pub. Date: Mar. 9, 2023

(54) SYSTEM AND METHOD FOR RECHARAGABLE BATTERY MODULE BY COMBINING CELLS OF VARYING SIZES

(71) Applicants: Mohammad Shafikul Huq, HAMTRAMCK, MI (US); Shakura Quabili, HAMTRAMCK, MI (US)

(72) Inventor: Mohammad S. Huq, HAMTRAMCK, MI (US)

(73) Assignees: Mohammad Shafikul Huq, HAMTRAMCK, MI (US); Shakura Quabili, HAMTRAMCK, MI (US)

(21) Appl. No.: 17/881,599

(22) Filed: Aug. 5, 2022

Related U.S. Application Data
(60) Provisional application No. 63/241,059, filed on Sep. 6, 2021.

(51) Int. Cl. H02J 7/00; H01M 50/204; H01M 50/267; H01M 50/258; H01M 10/44; H01M 10/48; B60L 53/60

(52) U.S. Cl. CPC H02J 7/007188; H02J 7/0048; H02J 7/0013; H02J 7/00041; H01M 50/204; H01M 50/267; H01M 50/258; H01M 10/446; H01M 10/441; H01M 10/482; B60L 53/60; H01M 2220/20

(57) ABSTRACT

The present invention is a system and method for formation and packaging of a rechargeable battery. Battery is packaged with multiple modules with each module containing cells of different sizes. A controller reads the state of charge of battery modules and if state of charge is low, battery modules with smaller cells are charged first. The system is comprising of battery modules with each module holding one size cells and the package holding modules of different cell sizes. It is possible to have each module formed with different cell sizes as well. Logics in the controller memory determines the recharging sequence of the battery modules and send charging command to recharging hardware.

### CROSS REFERENCE TO RELATED APPLICATION

This application is a continuation application of U.S. Provisional Patent Application No. 63/241059, filed Sep. 6, 2021 with conformation number 1791, the contents of which are incorporated herein by reference almost in their entirety, with claims unchanged.

### FIELD OF THE INVENTION

The present invention relates to formation and packaging of rechargeable batteries. Rechargeable batteries in electric vehicle and devices are built from multiple battery cells where each cell is one complete battery unit. The cells are usually of the same size and combined into a package together to make a battery module that is then used in vehicle or in other devices.

### BACKGROUND

Battery modules are made combining battery cells and then put together into a package. The formation is kept simple by keeping size of the cells same across the modules; simple formation strategy keeps the packaging cost low. If the number of cells is kept small by increasing size of each cell, the packaging cost goes even lower. Big cell size increases battery recharging time and small ones reduce the time.

The present invention proposes a compromising design to make a battery module by choosing cells of varying sizes. The compromise is between cost of packaging and convenience of quick recharging. If there are two or more sizes, two or more battery modules, each for one size of cells, are first formed. Then the modules are packaged together into one. While the packaging of smaller cells is costlier than the bigger ones, smaller cells get charged quicker and thus, in the time of crisis, a device with rechargeable battery can be charged quick. Modules with bigger cells can wait to be charged at a later time when a vehicle is not being driven or the device using the battery is not being used. The packaging of varying cell sizes can be done in different ways as well. For instance, each module could have cells of all sizes as opposed to just one. The main idea is to have cells of varying sizes with the design intent that the cells with small sizes will be quickly charged in the time of crisis.

### BRIEF SUMMARY OF THE INVENTION

The present invention is a system and method for formation and packaging of a rechargeable battery. Battery is packaged with multiple modules with each module containing cells of different sizes. A controller reads the state of charge of battery modules and if state of charge is low, battery modules with smaller cells are charged first. The system is comprising of battery modules with each module holding one size cells and the package holding modules of different cell sizes. Logics in the controller memory determines the recharging sequence of the battery modules and send charging command to recharging hardware.

### BRIEF DESCRIPTION OF THE DRAWINGS

System and method of the present invention are illustrated as an example and are not limited by the figure of the accompanying diagram, in which:

FIG. 1 depicts a system comprising a controller, recharging hardware, and battery modules with varying cell sizes.

### DETAILED DESCRIPTION OF THE INVENTION

The terminology used herein for the purpose of describing the system and method is not intended to be limiting the invention. The term ‘and/or” includes any and all combinations of one or more of the associated listed items. As used herein, the singular forms “a,” “an”, and “the” are intended to include the plural forms as well as singular forms, unless the context clearly indicates otherwise. The term “comprising” and/or “comprises” specify the presence, when used in this specification, specify the presence of stated features, steps operations, elements, and/r components, but do not preclude the presence or addition of one or more other features, steps, operations, elements, components, and/or groups/thereof.

If not otherwise defined, all terms used herein have the same meaning as commonly understood by one having ordinary skill in the art to which this invention belongs. Furthermore, terms, such as those defined in commonly used dictionaries, should be interpreted as having a meaning that is consistent with their meaning in the context of the relevant art and the present invention and will not be interpreted in an idealized or overly formal sense unless expressly so defined herein.

In the description of the invention, it will be understood that a number of techniques and steps are disclosed. Each of these has individual benefit and each can also be used in conjunction with one or more, or in some cases all, of the other disclosed techniques. Accordingly, for the sake of clarity, this description will refrain from repeating every possible combination of the individual steps in an unnecessary fashion. However, the specification and claims should be read with the understanding that such combinations are entirely within the scope of the invention and the claims.

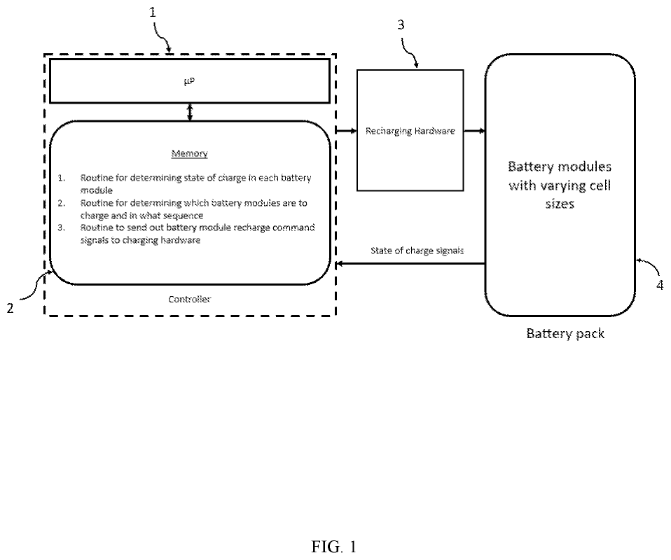

The present invention, a system and method will now be described by referencing the appended figure, FIG. 1, representing the preferred embodiments.

The present invention is a system and method for formation and packaging of a rechargeable battery. Battery is packaged with multiple modules with each module containing cells of different sizes. A controller 1 reads the state of charge of battery modules and if state of charge is low, battery modules with smaller cells are charged first. The system is comprising of battery modules with each module holding one size cells and the package holding modules of different cell sizes 4. The method is comprising logics in the controller memory 2 determines the recharging sequence of the battery modules and send charging command to recharging hardware 3.

1. A system with a rechargeable battery to be used for electric vehicle or a device that uses rechargeable battery, the system comprising:
a rechargeable battery package formed by combining modules of big and small rechargeable battery cell sizes, where the cells of different sizes could reside in one battery module with the package holding a plurality of battery modules or in different battery modules with each module having only one size of cells;
hardware module with capability to charge all the batteries separately or together; and
controllers to resolve charging sequence of the modules and determine the state of charge of the modules.

2. A method to determine charging sequence and state of charge of the modules, the method comprising steps:
determining state of charge in each battery module;
determining which battery modules are to charge and in what sequence;
charging battery modules with only smaller cell sizes first; and
generating battery module recharge command signal and sending to recharging hardware.
